(19) United States
(12) Patent Application Publication
(10) Pub. No.: US 2026/0360710 A1
(43) Pub. Date: Nov. 12, 2026

(54) POSITIVE ELECTRODE ACTIVE MATERIAL AND BATTERY

(71) Applicant: TOYOTA JIDOSHA KABUSHIKI KAISHA, Toyota-shi (JP)

(72) Inventor: Ryosuke OHSAWA, Okazaki-shi (JP)

(73) Assignee: TOYOTA JIDOSHA KABUSHIKI KAISHA, Toyota-shi (JP)

(21) Appl. No.: 19/456,224

(22) Filed: Jan. 22, 2026

(30) Foreign Application Priority Data
May 12, 2025 (JP) 2025-079939

(51) Int. Cl. H01M 4/36; C01G 53/502; H01M 4/02; H01M 4/525

(52) U.S. Cl. CPC H01M 4/366; C01G 53/502; H01M 4/525; C01P 2004/84; C01P 2006/40; H01M 2004/028

(57) ABSTRACT

The present disclosure provides a positive electrode active material including: a crystalline primary particle containing Li, a transition metal, and O, in which La and W are present on a surface of the primary particle, and in a case where an element analysis of the primary particle from an outermost surface to 20 nm is performed by X-ray photoelectron spectroscopy, and a proportion of La is defined as C_{La} and a proportion of W is defined as C_{W}, C_{La} and C_{W} satisfy 0.01≤C_{La}/C_{W}≤1.0.

### CROSS-REFERENCE TO RELATED APPLICATION

This application claims priority to Japanese Patent Application No. 2025-079939 filed on May 12, 2025. The disclosure of the above-identified application, including the specification, drawings, and claims, is incorporated by reference herein in its entirety.

### BACKGROUND

### 1. Technical Field

The present disclosure relates to a positive electrode active material and a battery.

### 2. Description of Related Art

In recent years, development of a battery has been actively carried out. For example, in the automotive industry, development of a battery used in a battery electric vehicle (BEV), a plug-in hybrid electric vehicle (PHEV), or a hybrid electric vehicle (HEV) has been carried out. As a positive electrode active material used in a battery, an active material containing a transition metal such as Ni, Co, and Mn is known.

For example, Japanese Unexamined Patent Application Publication (Translation of PCT Application) No. 2022-542774 (JP 2022-542774 A) discloses a W-containing high-nickel ternary positive electrode material having a chemical formula of LiₐNiₓCo_{y}Mn_{1-x-y}W_{b}McO₂. The high-nickel ternary positive electrode material contains spherical secondary particles and single crystal form particles at the same time, a W element is basically not contained in the single crystal form particles, and the W element is doped in the spherical secondary particles.

Japanese Unexamined Patent Application Publication (Translation of PCT Application) No. 2024-511223 (JP 2024-511223 A) discloses a single crystal multi-element positive electrode material, in which a ratio of the length of a longest diagonal line to the length of a shortest diagonal line that are measured by SEM on a single crystal particle of the single crystal multi-element positive electrode material is defined as a true circularity R, R is 1 or more, D₁₀, D₅₀, and D₉₀ of the single crystal particle of the single crystal multi-element positive electrode material satisfy K₉₀=(D₉₀−D₁₀)/D₅₀, and a product of K₉₀ and R is 1.20 to 1.40.

Hujun Zhang et al., “Perovskite-coated small-size single-crystalline W-doped Ni-rich cathodes with greatly enhanced power density for Li-ion batteries”, Journal of Materials Chemistry A, Issue 36, 2024 discloses that W is doped in LiNi_{0.85}Co_{0.05}Mn_{0.10}O₂, and further, La₄NiLiO₈ perovskite coating is performed.

### SUMMARY

From the viewpoint of improving battery performance, it is desired to reduce resistance. The present disclosure has been made in view of the above circumstances, and a main object thereof is to provide a positive electrode active material having reduced resistance.

1

A positive electrode active material including
a primary particle that is crystalline, the primary particle containing Li, a transition metal, and O, in which
La and W are present on a surface of the primary particle, and
in a case where an element analysis is performed from an outermost surface of the primary particle to 20 nm by X-ray photoelectron spectroscopy, and a proportion of La is defined as
C_{La} and a proportion of W is defined as C_{W},
C_{La} and C_{W} satisfy 0.01≤C_{La}/C_{W}≤1.0.
   2

The positive electrode active material according to 1, in which a compound containing La and a compound containing W are provided on the surface of the primary particle, and the compound containing La and the compound containing W are compounds having different compositions.

3

The positive electrode active material according to 2, in which the compound containing La is particulate.

4

The positive electrode active material according to 2, in which the compound containing W is pellicular.

5

A battery including a positive electrode active material layer containing a positive electrode active material, a negative electrode active material layer containing a negative electrode active material, and an electrolyte layer disposed between the positive electrode active material layer and the negative electrode active material layer, in which the positive electrode active material layer contains the positive electrode active material according to any one of 1 to 4.

The present disclosure can provide a positive electrode active material having reduced resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic cross-sectional view illustrating a positive electrode active material in the present disclosure;

FIG. 1B is a schematic cross-sectional view illustrating the positive electrode active material in the present disclosure;

FIG. 2 is a schematic cross-sectional view illustrating a battery in the present disclosure; and

FIG. 3 is a flowchart illustrating a method of manufacturing the positive electrode active material in the present disclosure.

### DETAILED DESCRIPTION OF EMBODIMENTS

Hereinafter, embodiments will be described with reference to the drawings or the like; however, the present disclosure can be implemented in many different aspects, and the description of the embodiments exemplified below is not intended to limit the present disclosure. In addition, in order to make the description clearer, the drawings may schematically show the width, thickness, and shape of each part as compared with the actual form, but this is merely an example and is not intended to be limiting.

### A. Positive Electrode Active Material

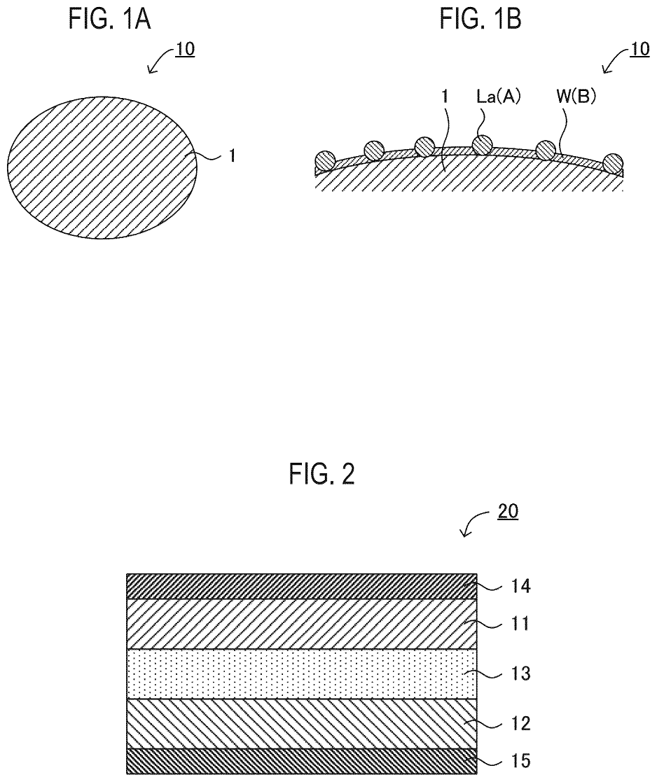

FIGS. 1A and 1B are schematic cross-sectional views illustrating a positive electrode active material in the present disclosure. In FIG. 1A, for convenience, the description of La and W is omitted. As shown in FIGS. 1A and 1B, a positive electrode active material 10 has a crystalline primary particle 1 containing Li, TM (TM is a transition metal), and O. An element analysis of the primary particle 1 from an outermost surface to 20 nm is performed by X-ray photoelectron spectroscopy, and a proportion of La is defined as C_{La} and a proportion of W is defined as C_{W}. In the present disclosure, C_{La}/C_{W} is in a specific range.

According to the present disclosure, since C_{La}/C_{W} is in a specific range, a positive electrode active material having reduced resistance is obtained. Specifically, it is presumed that, since La is present on the surface of the primary particle, the electron conductivity is improved, and since W is present, the ion conductivity is improved, and the resistance can be reduced. In addition, in a case where La is present on the surface of the primary particle, the ion conductivity may be reduced. In a case where W is present, the electron conductivity may be reduced, but it is presumed that, since C_{La}/C_{W} is in a specific range, the improvement of the electron conductivity and the improvement of the ion conductivity can be balanced and both can be achieved, and the resistance can be reduced.

### 1. Primary Particle

The primary particle in the present disclosure is a crystalline particle containing Li, TM (TM is a transition metal), and O. Examples of the crystal structure of the primary particle include a layered rock salt type and a spinel type, and a layered rock salt type is preferable. In addition, the primary particle may have a crystal structure belonging to a space group R-3m.

The primary particle contains Li, TM (TM is a transition metal), and O. The primary particle may contain one kind of transition metal, may contain two kinds of transition metals, may contain three kinds of transition metals, or may contain four or more kinds of transition metals.

The transition metal is a metal belonging to Group 3 to Group 11 in the periodic table. The transition metal contained in the primary particle may be a metal belonging to the third period, the fourth period, or the fifth period. Examples of the transition metal include Ti, V, Cr, Mn, Fe, Co, Ni, Zr, Nb, La, and W.

It is preferable that the primary particle contains at least Ni. This is because a positive electrode active material having favorable capacity characteristics can be obtained. In a case where all the transition metals (TM) contained in the primary particle are defined as 1 part by mole, a proportion of Ni contained in the primary particle is, for example, 0.25 parts by mole or more, and may be 0.33 parts by mole or more, 0.50 parts by mole or more, 0.75 parts by mole or more, 0.80 parts by mole or more, or 0.90 parts by mole or more. By increasing the proportion of Ni, the capacity characteristics are improved.

The primary particle may contain Co or may not contain Co. In a case where all the transition metals (TM) contained in the primary particle are defined as 1 part by mole, a proportion of Co contained in the primary particle is, for example, 0 parts by mole or more, and may be 0.05 parts by mole or more, or 0.10 parts by mole or more. On the other hand, the proportion of Co contained in the primary particle is, for example, 0.40 parts by mole or less, and may be 0.20 parts by mole or less.

The primary particle may contain Mn or may not contain Mn. In a case where all the transition metals (TM) contained in the primary particle are defined as 1 part by mole, a proportion of Mn contained in the primary particle is, for example, 0 parts by mole or more, and may be 0.05 parts by mole or more, or 0.10 parts by mole or more. On the other hand, the proportion of Mn contained in the primary particle is, for example, 0.40 parts by mole or less, and may be 0.20 parts by mole or less.

It is preferable that the primary particle contains at least one of Ni, Co, or Mn. In a case where all the metals (excluding Li) contained in the primary particle are defined as 1 part by mole, a total proportion of Ni, Co, and Mn contained in the primary particle is, for example, 0.80 parts by mole or more, and may be 0.90 parts by mole or more, or 0.95 parts by mole or more. In addition, the “total of Ni, Co, and Mn” includes a case where the proportion of one or two of Ni, Co, and Mn is 0.

The primary particle may contain, in addition to Li and TM, another metal M¹ (including a metalloid) other than Li and TM. Examples of the other metal M¹ include a metal belonging to Group 12 to Group 14 in the periodic table. Examples of the metal belonging to Group 12 to Group 14 include Zn, Al, Si, Ga, Ge, In, and Sn.

A composition of the primary particle is not particularly limited, but may be, for example, a composition represented by a general formula LiₓNiₐCo_{b}Mn_{c}O_{y} (0.1≤x≤1.5, 0.5≤a≤1.0, 0≤b≤0.3, 0≤c≤0.3, 0.001≤d≤0.1, 0.001≤e≤0.1, a+b+c+d+e=1.0, 1.5≤y≤2.1).

A particle diameter of the primary particle is, for example, 0.5 μm or more, and may be 0.6 μm or more, 0.8 μm or more, or 1.0 μm or more. In a case where the particle diameter of the primary particle is too small, the particles may not grow sufficiently, and it may be difficult to produce the particles as single crystals. On the other hand, the particle diameter of the primary particle is, for example, 20 μm or less, and may be 15 μm or less, 10 μm or less, or 5 μm or less. The particle diameter of the primary particle is obtained, for example, as a longest diameter in SEM observation. In addition, for example, in a case where the primary particle (positive electrode active material) is contained in the positive electrode active material layer, the particle diameter (longest diameter) of the primary particle may be obtained from a cross-sectional image of the positive electrode active material layer.

### 2. La and W

In the present disclosure, La and W are present on the surface of the primary particle. In addition, an element analysis of the primary particle from an outermost surface to 20 nm is performed by X-ray photoelectron spectroscopy, and a proportion of La is defined as C_{La} and a proportion of W is defined as C_{W}. C_{La} and C_{W} usually satisfy 0.01≤C_{La}/C_{W}≤1.0.

C_{La}/C_{W} may be 0.1 or more, 0.2 or more, 0.3 or more, 0.4 or more, or 0.5 or more. On the other hand, C_{La}/C_{W} may be 0.95 or less, or 0.9 or less. C_{La} and C_{W} can be measured by X-ray photoelectron spectroscopy. Details of the measurement method of C_{La} and C_{W} will be described in Embodiments.

In a case where all the transition metals contained in the primary particle are defined as 1 part by mole, a proportion of La contained in the primary particle is, for example, 0.001 parts by mole or more, and may be 0.003 parts by mole or more, or 0.005 parts by mole or more. On the other hand, the proportion of La contained in the primary particle is, for example, 0.100 parts by mole or less, and may be 0.080 parts by mole or less, or 0.060 parts by mole or less.

In a case where all the transition metals contained in the primary particle are defined as 1 part by mole, a proportion of W contained in the primary particle is, for example, 0.001 parts by mole or more, and may be 0.003 parts by mole or more, or 0.005 parts by mole or more. On the other hand, the proportion of W contained in the primary particle is, for example, 0.100 parts by mole or less, and may be 0.080 parts by mole or less, or 0.060 parts by mole or less.

A coating rate of La on the primary particle is not particularly limited, but is, for example, 10% or more and 90% or less, and may be 20% or more and 80% or less, or 30% or more and 70 or less. The coating rate of La can be obtained from, for example, an outermost surface analysis by X-ray photoelectron spectroscopy (XPS). For example, in a case where the primary particle contains Ni, Co, and Mn as the transition metal TM, the amount of La and the amount of each TM (amount of Ni, amount of Co, amount of Mn) can be obtained by the outermost surface analysis by XPS, and La/(La+TM) can be used as the coating rate.

A coating rate of W on the primary particle is not particularly limited, but is, for example, 10% or more and 90% or less, and may be 20% or more and 80% or less, or 30% or more and 70 or less. The coating rate of W can be obtained from, for example, the outermost surface analysis by X-ray photoelectron spectroscopy (XPS) in the same manner as described above.

The primary particle may have a compound A containing La on the surface. The compound A is usually a compound having a composition different from the compound B described later. In addition, the compound A may not contain W. The compound A contains, for example, La, Ni, and O. The compound A may be composed of only La, Ni, and O, or may further contain other elements. Examples of the other elements include Li. That is, the compound A may contain Li, La, Ni, and O.

Examples of the composition of the compound A include LaₐNi_{b}O_{c} (0.8≤a≤1.2, 0.8≤b≤1.2, 2.8≤c≤3.2). For example, LaNiO₃ has a typical perovskite composition and has favorable electron conductivity. Examples of the composition of the compound A include LaₐLi_{b}Ni_{c}O_{d} (3.5≤a≤4.5, 0.5≤b≤1.5, 0.5≤c≤1.5, 7.5≤d≤8.5). For example, it is known that La₄LiNiO₈ has favorable electron conductivity, and a crystal phase similar to perovskite is provided.

The compound A may be crystalline or amorphous, but the former is preferable. This is because favorable electron conductivity can be obtained. The “compound is crystalline” means that a peak derived from the compound to be measured is confirmed by X-ray diffraction using a CuKα ray. On the other hand, the “compound is amorphous” means that a peak derived from the compound to be measured is not confirmed by X-ray diffraction using a CuKα ray. In a case where the compound to be measured is amorphous, a halo pattern may be observed instead of a peak.

The compound A preferably has a perovskite crystal phase or a crystal phase similar to perovskite. The compound A preferably has at least one of a crystal phase of LaNiO₃ or La₄LiNiO₈. This is because favorable electron conductivity can be obtained. The crystal phase includes a crystal phase in which a part of the constituent atoms (for example, a part of O atoms) is missing and a crystal phase in which a part of the constituent atoms (for example, a part of La atoms) is in excess.

The compound A may have a particle shape. The “compound A has a particle shape” means that, in a cross-sectional image of the primary particle, in a case where a length of the compound A in a normal direction of the surface of the primary particle is defined as L₁ and a length of the compound A in a direction perpendicular to the normal direction is defined as L₂, a ratio (L₂/L₁) of L₂ to L₁ is 3.0 or less. The cross-sectional image of the primary particle is, for example, an SEM cross-sectional image. The electron conductivity of the compound A at 25 °C is, for example, 5.0×10⁻⁴ S/cm or more, and may be 1.0×10⁻³ S/cm or more.

The primary particle may have a compound B containing W on the surface. In addition, the compound B may not contain La. The compound B contains, for example, Li, W, and O. The compound B may be composed of only Li, W, and O, or may further contain other elements.

Examples of the composition of the compound B include LiₐW_{b}O_{c} (5.5≤a≤6.5, 0.5≤b≤1.5, 5.5≤c≤6.5). The compound B having the above composition is typically Li₆WO₆. Examples of the composition of the compound B include LiₐW_{b}O_{c} (1.5≤a≤2.5, 0.5≤b≤1.5, 3.5≤c≤4.5). The compound B having the above composition is typically Li₂WO₄. In addition, examples of the composition of the compound B include LiₐW_{b}O_{c} (3.5≤a≤4.5, 0.5≤b≤1.5, 4.5≤c≤5.5). The compound B having the above composition is typically Li₄WO₅. In addition, examples of the composition of the compound B include LiₐW_{b}O_{c} (1.5≤a≤2.5, 1.5≤b≤2.5, 6.5≤c≤7.5). The compound B having the above composition is typically Li₂W₂O₇.

The compound B may be crystalline or amorphous. In addition, the compound B may have a pellicular shape. The “compound B has a pellicular shape” means that, in a cross-sectional image of the primary particle, in a case where a length of the compound B in a normal direction of the surface of the primary particle is defined as L₃ and a length of the compound B in a direction perpendicular to the normal direction is defined as L₄, a ratio (L₄/L₃) of L₄ to L₃ is greater than 3.0. The cross-sectional image of the primary particle is, for example, a transmission electron microscope (TEM) cross-sectional image. A thickness (length L₃) of the compound B is not particularly limited, but is, for example, 0.5 nm or more and 20 nm or less, and may be 1 nm or more and 15 nm or less. The ion conductivity of the compound B at 25 °C is, for example, 1.0×10⁻⁵ S/cm or more, and may be 1.0×10⁻⁴ S/cm or more.

### 3. Positive Electrode Active Material

The positive electrode active material in the present disclosure may be a single crystal-based active material composed of the primary particles. The single crystal-based active material is usually not aggregated and exists as one independent particle. In the single crystal-based active material, grain boundaries are preferably not confirmed in a scanning electron microscope (SEM) observation (magnification: about 10,000 to 30,000 times). On the other hand, the positive electrode active material in the present disclosure may be an active material in which a plurality of the primary particles are aggregated.

A method of manufacturing the positive electrode active material is not particularly limited, but examples thereof include a method described in “D. Method of manufacturing positive electrode active material” described later.

In addition, in the present disclosure, a positive electrode active material powder can also be provided, in which the positive electrode active material powder has a plurality of crystalline primary particles containing Li, TM (TM is a transition metal), and O as the positive electrode active material, a part of the plurality of primary particles is a primary particle X, the primary particle X has La and W on a surface thereof, in a case where an element analysis of the primary particle X from an outermost surface to 20 nm is performed by X-ray photoelectron spectroscopy, and a proportion of La is defined as C_{La} and a proportion of W is defined as C_{W}, C_{La} and C_{W} satisfy 0.01≤C_{La}/C_{W}≤1.0. In addition, a proportion of the primary particle X to all the positive electrode active materials in the positive electrode active material powder is, for example, 5% by mass or more, and may be 10% by mass or more, 20% by mass or more, 30% by mass or more, 40% by mass or more, 50% by mass or more, 60% by mass or more, or 70% by mass or more. The primary particle X may be a single crystal-based active material, or may be an active material in which a plurality of primary particles X are aggregated.

### B. Positive Electrode Mixture

In the present disclosure, a positive electrode mixture containing the above-described positive electrode active material can also be provided.

According to the present disclosure, by using the above-described positive electrode active material, a positive electrode mixture having reduced resistance is obtained. The positive electrode mixture may contain other materials (for example, a conductive material and a binder) in addition to the positive electrode active material. In addition, the positive electrode mixture may contain the above-described positive electrode active material powder. In addition, the positive electrode mixture may be in a powder form or a slurry form containing a dispersion medium.

A proportion of the positive electrode active material in the solid content of the positive electrode mixture is, for example, 20% by mass or more, and may be 30% by mass or more, or 40% by mass or more. In a case where the proportion of the positive electrode active material is too small, there is a possibility that a sufficient energy density cannot be obtained. On the other hand, the proportion of the positive electrode active material in the solid content of the positive electrode mixture is, for example, 95% by mass or less, and may be 70% by mass or less, or 60% by mass or less. In a case where the proportion of the positive electrode active material is too large, the ion conductivity and the electron conductivity may be relatively reduced.

The positive electrode mixture may contain a conductive material. By adding the conductive material, the electron conductivity is improved. Examples of the conductive material include a carbon-based conductive material, metal particles, and a conductive polymer. Examples of the carbon-based conductive material include a particle-shaped material such as acetylene black (AB) and Ketjen black (KB), and a fiber-shaped material such as vapor-grown carbon fiber (VGCF), carbon nanotube (CNT), and carbon nanofiber (CNF).

The positive electrode mixture may contain a binder. By adding the binder, a positive electrode active material layer in which the positive electrode active material is less likely to fall off can be obtained. Examples of the binder include a rubber-based binder such as styrene-butadiene rubber (SBR) and butadiene rubber (BR), a polycarboxylic acid-based binder such as carboxymethyl cellulose, and a fluorinated binder such as polyvinylidene fluoride (PVdF).

### C. Battery

FIG. 2 is a schematic cross-sectional view illustrating a battery in the present disclosure. A battery 20 illustrated in FIG. 2 includes a positive electrode active material layer 11, a negative electrode active material layer 12, an electrolyte layer 13 disposed between the positive electrode active material layer 11 and the negative electrode active material layer 12, a positive electrode collector 14 that collects the positive electrode active material layer 11, and a negative electrode collector 15 that collects the negative electrode active material layer 12. In the present disclosure, the positive electrode active material layer 11 contains the positive electrode active material described in “A. Positive electrode active material” or the positive electrode mixture described in “B. Positive electrode mixture”.

According to the present disclosure, by using the above-described positive electrode active material or positive electrode mixture, a battery having reduced resistance is obtained.

### 1. Positive Electrode Active Material Layer

The positive electrode active material layer contains at least the positive electrode active material. In addition, the positive electrode active material layer may contain a conductive material and a binder. The positive electrode active material, the conductive material, and the binder are the same as those described in “A. Positive electrode active material” and “B. Positive electrode mixture” described above.

The positive electrode active material layer may contain an electrolyte. The electrolyte is, for example, an electrolytic solution described later. On the other hand, the positive electrode active material layer may contain a solid electrolyte. A thickness of the positive electrode active material layer is, for example, 0.1 μm or more and 1000 μm or less, and may be 1 μm or more and 500 μm or less, or 30 μm or more and 100 μm or less.

### 2. Negative Electrode Active Material Layer

The negative electrode active material layer contains at least the negative electrode active material. Examples of the negative electrode active material include a carbon-based active material, an Li-based active material, an Si-based active material, and an oxide-based active material.

Examples of the carbon-based active material include graphite, soft carbon, and hard carbon. The graphite may be natural graphite or artificial graphite. Examples of the Li-based active material include Li and an Li alloy. Examples of the Li alloy include an Li—Si alloy. Examples of the Si-based active material include Si, a SiC composite active material, an Si alloy, and an Si oxide. Examples of the SiC composite active material include an active material in which Si or an Si alloy is supported on a carbon carrier. Examples of the oxide-based active material include lithium titanate such as Li₄Ti₅O₁₂.

The negative electrode active material layer may contain at least one of a conductive material, a binder, or an electrolyte. Details of the conductive material, the binder, and the electrolyte are the same as those described in “1. Positive Electrode Active Material Layer” described above. In addition, a thickness of the negative electrode active material layer is, for example, 0.1 μm or more and 1000 μm or less, and may be 1 μm or more and 500 μm or less, or 30 μm or more and 100 μm or less.

### 3. Electrolyte Layer

The electrolyte layer is a layer disposed between the positive electrode active material layer and the negative electrode active material layer, and contains at least an electrolyte. The electrolyte is, for example, a liquid electrolyte (electrolytic solution).

Examples of the electrolytic solution include an non-aqueous electrolytic solution. The non-aqueous electrolytic solution contains, for example, a lithium salt and a non-aqueous solvent. Examples of the lithium salt include inorganic lithium salts such as LiPF₆, LiBF₄, LiClO₄, and LiAsF₆; and organic lithium salts such as LiCF₃SO₃, LiN(SO₂CF₃)₂, LiN(SO₂C₂F₅)₂, and LiC(SO₂CF₃)₃.

Examples of the non-aqueous solvent include carbonate-based solvents such as ethylene carbonate (EC), propylene carbonate (PC), butylene carbonate (BC), dimethyl carbonate (DMC), diethyl carbonate (DEC), and ethyl methyl carbonate (EMC). The non-aqueous electrolytic solution may contain an ionic liquid. In addition, examples of the electrolytic solution include an aqueous electrolytic solution. Furthermore, the electrolyte layer may include a separator impregnated with the above-described electrolytic solution.

### 4. Battery

The battery in the present disclosure preferably includes a positive electrode collector that collects the positive electrode active material layer and a negative electrode collector that collects the negative electrode active material layer.

A type of the battery in the present disclosure is not particularly limited, but is typically a lithium ion battery. In addition, the battery in the present disclosure may be a primary battery or a secondary battery, but is preferably a secondary battery. This is because the battery can be repeatedly charged and discharged and is useful as, for example, a vehicle-mounted battery. Examples of an application of the battery include a power source of a vehicle such as a hybrid electric vehicle (HEV), a plug-in hybrid electric vehicle (PHEV), a battery electric vehicle (BEV), a gasoline vehicle, and a diesel vehicle. In particular, it is preferably used as a power source for driving a hybrid electric vehicle (HEV), a plug-in hybrid electric vehicle (PHEV), or a battery electric vehicle (BEV). In addition, the battery may be used as a power source of a moving object (for example, a railway, a ship, or an aircraft) other than a vehicle, or may be used as a power source of an electric product such as an information processing apparatus.

### D. Method of Manufacturing Positive Electrode Active Material

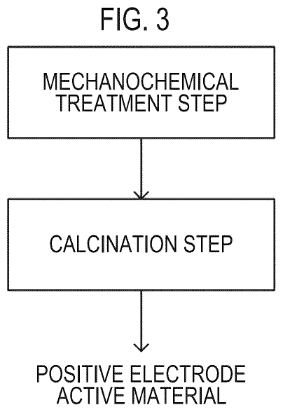

In the present disclosure, a method of manufacturing a positive electrode active material, the method being of manufacturing the above-described positive electrode active material, can also be provided. As illustrated in FIG. 3, the method of manufacturing a positive electrode active material preferably includes a mechanochemical treatment step of subjecting a first mixture containing a transition metal hydroxide containing the above-described TM, a Li source, and a La source to a mechanochemical treatment, and a calcination step of adding a W source to the mechanochemically treated first mixture to prepare a second mixture, and calcining the second mixture to obtain a calcined body.

According to the present disclosure, by performing the mechanochemical treatment step and the calcination step, a positive electrode active material having reduced resistance can be obtained.

### 1. Mechanochemical Treatment Step

The mechanochemical treatment step is a step of subjecting a first mixture containing a transition metal hydroxide containing the above-described TM, a Li source, and a La source to a mechanochemical treatment.

The transition metal hydroxide contains TM (TM is a transition metal). The transition metal hydroxide corresponds to a precursor of the positive electrode active material. The transition metal hydroxide may contain Ni or may not contain Ni.

A method of synthesizing the transition metal hydroxide is not particularly limited, but examples thereof include the following methods. First, an aqueous raw material solution of the transition metal hydroxide is prepared. Examples of a method of preparing the aqueous raw material solution include a method of dissolving a water-soluble transition metal compound in water. Examples of the transition metal compound include metal salts such as a sulfate and a nitrate. Examples of the Ni source include NiSO₄ and Ni(NO₃)₂. Examples of the Co source include CoSO₄, Co(NO₃)₂, and Co(NO₃)₃. Examples of the Mn source include MnSO₄ and Mn(NO₃)₂. A composition of the aqueous raw material solution is appropriately adjusted corresponding to a positive electrode active material to be obtained.

Next, a sodium hydroxide aqueous solution is added to the reaction container, and the aqueous raw material solution and the NH₃ aqueous solution are added dropwise while maintaining the pH in an alkaline range (for example, pH 11.3 to 12.0). A reaction temperature is not particularly limited, but is, for example, 50 °C or higher and 65 °C or lower. After the reaction is completed, it is preferable to filter the reaction solution to take out the transition metal hydroxide, and then wash the transition metal hydroxide with water and dry the transition metal hydroxide.

In the mechanochemical treatment step, the first mixture containing the transition metal hydroxide, the Li source, and the La source is subjected to a mechanochemical treatment. Examples of the Li source include lithium hydroxide, lithium carbonate, lithium nitrate, lithium acetate, lithium oxide, and lithium chloride. The Li source may be lithium hydroxide or may be a Li-containing compound other than lithium hydroxide. A molar ratio of Li in the Li source to TM contained in the transition metal hydroxide is, for example, 0.8 or more and 1.2 or less, and may be 0.9 or more and 1.1 or less, or may be 1.0.

Examples of the La source include a hydroxide; and a metal salt such as a sulfate and a nitrate. Examples of the La source include La(OH)₃, LaSO₄, and La(NO₃)₃. An addition amount of the La source is appropriately adjusted corresponding to a positive electrode active material to be obtained.

The first mixture preferably has a molten salt. By functioning as a flux, the molten salt can sufficiently grow the primary particles. The molten salt may contain Li. Examples of the molten salt include lithium hydroxide. A molar ratio (Li/TM) of Li contained in the molten salt to TM contained in the transition metal hydroxide is, for example, 0.1 or more and less than 0.6. Li/TM may be 0.15 or more, 0.2 or more, or 0.25 or more. On the other hand, Li/TM may be 0.55 or less, or 0.5 or less.

The mechanochemical treatment is a treatment of changing chemical properties of a raw material by applying mechanical energy such as impact, shear, and friction to the raw material. Examples of a device for the mechanochemical treatment include a particle composite device and a ball mill device. A time of the mechanochemical treatment is not particularly limited, but is, for example, 15 minutes or longer and 10 hours or shorter.

### 2. Calcination Step

The calcination step is a step of adding a W source to the mechanochemically treated first mixture to prepare a second mixture, and calcining the second mixture to obtain a calcined body.

Examples of the W source include H₂WO₄. An addition amount of the W source is appropriately adjusted corresponding to a positive electrode active material to be obtained.

A temperature in the calcination step is, for example, 700 °C or higher and 1100 °C or lower, and may be 800 °C or higher and 1000 °C or lower. In addition, a firing time in the calcination step is, for example, 1 hour or longer and 15 hours or shorter, and may be 5 hours or longer and 12 hours or shorter. An atmosphere in the calcination step is usually an atmosphere in which oxygen is present. Examples of a firing method in the calcination step include a method of using a firing furnace such as a muffle furnace and an electric furnace.

In the calcination step, a pulverization treatment of pulverizing the calcined body may be performed. Examples of a pulverization method in the pulverization treatment include a jet mill, a hammer mill, a lab mill, and a ball mill.

### 3. Positive Electrode Active Material

The positive electrode active material obtained by each of the above-described steps is the same as the content described in “A. Positive electrode active material” described above.

The present disclosure is not limited to the above-described embodiment. The above-described embodiment is an example, and any configuration having a substantially same configuration as the technical idea described in the claims of the present disclosure and exhibiting the same action and effect is included in the technical scope of the present disclosure.

### Comparative Example 1

### Production of Positive Electrode Active Material

As a raw material, NiSO₄, CoSO₄, and MnSO₄ were prepared, and these were dissolved in ion exchange water to prepare a raw material aqueous solution. A proportion of Ni, Co, and Mn in the raw material aqueous solution was set to Ni:Co:Mn=8:1:1 in terms of molar ratio. In addition, a concentration of the raw material aqueous solution (proportion of all raw materials to the raw material aqueous solution) was 30% by mass.

Thereafter, a certain amount of an NH₃ aqueous solution was added to the reaction container, and the inside of the reaction container was replaced with nitrogen while stirring with a stirrer. A NaOH aqueous solution was added to the reaction container, the pH was maintained in an alkaline range (pH=12), and the raw material aqueous solution and the NH₃ aqueous solution were added dropwise while controlling the temperature to a certain temperature, thereby precipitating the transition metal hydroxide. The reaction temperature was set to 60 °C, and the reaction time was set to 3 hours. Next, the precipitated transition metal hydroxide was taken out by filtration, and washed with water by adding ion exchange water and dispersing with a spoon. The transition metal hydroxide after washing with water was dried under the conditions of 120 °C and 16 hours to obtain a transition metal hydroxide as a precursor.

Thereafter, a Li source (LiOH) was added to the obtained precursor, and mixed with an agate mortar to obtain a first mixture. An addition amount of the Li source was adjusted such that a molar ratio (Li/NCM) of Li contained in the Li source to the total of Ni, Co, and Mn contained in the precursor (NCM) was 1.1. The obtained first mixture was calcined in a firing furnace under the conditions of 900 °C, an oxygen atmosphere, and 10 hours to obtain a calcined body. The obtained calcined body was crushed using a jet mill to adjust the particle diameter, thereby obtaining a positive electrode active material.

### Production of Battery

A battery was produced using the obtained positive electrode active material. Specifically, a positive electrode mixture paste containing the positive electrode active material, a conductive material (acetylene black), and a binder (polyvinylidene fluoride) at a mass ratio of positive electrode active material:conductive material:binder=88:10:2 was applied onto a surface of a metal foil which was a positive electrode collector, using a film applicator with a film thickness adjustment function (manufactured by Allgrid Co., Ltd.). Thereafter, the positive electrode mixture was dried at 80 °C for 5 minutes in a dryer to obtain a positive electrode having a positive electrode collector and a positive electrode active material layer.

Next, a negative electrode mixture paste containing a negative electrode active material (natural graphite) and a binder (SBR and CMC) was applied onto a surface of a metal foil which was a negative electrode collector, using a film applicator with a film thickness adjustment function (manufactured by Allgrid Co., Ltd.). Thereafter, the negative electrode mixture was dried at 80 °C for 5 minutes in a dryer to obtain a negative electrode having a negative electrode collector and a negative electrode active material layer. Next, as an electrolytic solution, a LiPF₆ solution having a concentration of 1 M was prepared. As a solvent of the electrolytic solution, a mixed solvent obtained by mixing ethylene carbonate (EC), dimethyl carbonate (DMC), and ethyl methyl carbonate (EMC) at a volume ratio of EC:DMC:EMC=3:4:3 was used. A wound cylindrical battery was obtained using the positive electrode, the negative electrode, and the electrolytic solution.

### Comparative Example 2

A first mixture was obtained in the same manner as in Comparative Example 1. The obtained first mixture was subjected to a mechanochemical treatment under the conditions of 2000 rpm and 30 minutes using a particle composite device (NOBILTA MINI). Thereafter, the mechanochemically treated first mixture was calcined in a firing furnace under the conditions of 900 °C, an oxygen atmosphere, and 10 hours to obtain a calcined body. The obtained calcined body was crushed using a jet mill to adjust the particle diameter, thereby obtaining a positive electrode active material.

### Embodiment 1

A Li source (LiOH) and a La source (La(OH)₃) were added to the obtained precursor, and mixed with an agate mortar to obtain a first mixture in the same manner as in Comparative Example 1. An addition amount of the Li source was adjusted such that a molar ratio (Li/NCM) of Li contained in the Li source to the total of Ni, Co, and Mn contained in the precursor (NCM) was 1.1. In addition, an addition amount of the La source was adjusted such that La/NCM was 0.01. The obtained first mixture was subjected to a mechanochemical treatment under the conditions of 1000 rpm and 30 minutes using a particle composite device (NOBILTA MINI). Thereafter, a W source (H₂WO₄) was added to the mechanochemically treated first mixture, and mixed with an agate mortar to obtain a second mixture. An addition amount of the W source was adjusted such that W/NCM was 0.01. The obtained second mixture was calcined in a firing furnace under the conditions of 900 °C, an oxygen atmosphere, and 10 hours to obtain a calcined body. The obtained calcined body was crushed using a jet mill to adjust the particle diameter, thereby obtaining a positive electrode active material. A battery was obtained in the same manner as in Comparative Example 1, except that the obtained positive electrode active material was used.

### Embodiment 2

A positive electrode active material and a battery were obtained in the same manner as in Embodiment 1, except that the conditions of the mechanochemical treatment were changed to 2000 rpm and 30 minutes.

### Embodiment 3

A positive electrode active material and a battery were obtained in the same manner as in Embodiment 1, except that the conditions of the mechanochemical treatment were changed to 3000 rpm and 30 minutes.

### Embodiment 4

A positive electrode active material and a battery were obtained in the same manner as in Embodiment 1, except that the addition amount of the La source was changed such that La/NCM was 0.001.

### Embodiment 5

A positive electrode active material and a battery were obtained in the same manner as in Embodiment 1, except that the addition amount of the W source was changed such that W/NCM was 0.005.

### Evaluation

### XPS Measurement

Element analysis of the positive electrode active materials obtained in Embodiments 1 to 5 and Comparative Embodiments 1, 2 from the outermost surface to 20 nm of the primary particles was performed by X-ray photoelectron spectroscopy (XPS). Specifically, XPS measurement was performed using an XPS analysis device “PHI5000 VersaProbe II” (manufactured by ULVAC-PHI, Inc.). Specifically, composition analysis of the measurement element was performed to obtain the concentrations (Atomic %) of La and W, respectively, and the integrated values of the concentrations from 0 nm to 20 nm were obtained as C_{La} and C_{W}, respectively, and C_{La}/C_{W} was calculated. The measurement conditions were as follows.
X-ray source: AlKα monochromatized ray
Irradiation range φ100 μm HP (1400×200)
Current-voltage: 100 W, 20 kV
Neutralization gun: ON
Pass energy: 187.85 eV (wide), 46.95 to 117.40 eV (narrow)
Step: 0.4 eV (wide), 0.1 eV (narrow)
Shift correction: C—C, C—H (C1s, 284.8 eV)
Peak information: Handbook of XPS (ULVAC-PHI)
   In addition, the depth analysis was performed by etching with Ar monomer, and the voltage was set to 3 kV, the irradiation area was set to 2×2 mm, and the sputtering rate was set to 6.5 nm/min. The results are shown in Table 1.

### Initial Resistance

The initial resistance was measured using the batteries obtained in Embodiments 1 to 5 and Comparative Embodiments 1, 2. Specifically, the above-described battery was charged to 4.3 V, and then discharged to 3.7 V. Thereafter, the voltage drop (V) in a case of discharging for 10 seconds under the conditions of each C-rating of 0.1 C, 0.3 C, 0.5 C, 0.7 C, and 1.0 C at 0 °C was measured. A relationship between the voltage drop (V) and the current value was plotted, and a slope in a case of drawing an approximate straight line with a linear function was defined as a resistance (IV resistance). The results are shown in Table 1. The value of the initial resistance in Table 1 is a relative value in a case where the initial resistance of Comparative Example 1 is 100%.

TABLE 1

| | | | | | | | | | Initial |
|---|---|---|---|---|---|---|---|---|---|
| | Ratio | | | | | | Mechanochemical | | Resistance |
| | Li | Ni | Co | Mn | La | W | Condition | C_{La}/C_{w} | (%) |
| Comparative Example 1 | 1.1 | 0.8 | 0.1 | 0.1 | — | — | — | — | 100 |
| Comparative Example 2 | 1.1 | 0.8 | 0.1 | 0.1 | — | — | 2000 rpm | — | 101 |
| Embodiment 1 | 1.1 | 0.8 | 0.1 | 0.1 | 0.010 | 0.010 | 1000 rpm | 0.9 | 84 |
| Embodiment 2 | 1.1 | 0.8 | 0.1 | 0.1 | 0.010 | 0.010 | 2000 rpm | 0.5 | 82 |
| Embodiment 3 | 1.1 | 0.8 | 0.1 | 0.1 | 0.010 | 0.010 | 3000 rpm | 0.2 | 81 |
| Embodiment 4 | 1.1 | 0.8 | 0.1 | 0.1 | 0.001 | 0.010 | 2000 rpm | 0.01 | 80 |
| Embodiment 5 | 1.1 | 0.8 | 0.1 | 0.1 | 0.010 | 0.005 | 2000 rpm | 1.0 | 83 |

As shown in Table 1, it was confirmed that Embodiments 1 to 5 had a lower initial resistance than Comparative Embodiments 1, 2. As described above, it is presumed that, since La is present on the surface of the primary particle, the electron conductivity is improved, and since W is present, the ion conductivity is improved, and the resistance can be reduced. Furthermore, it is presumed that, since C_{La}/C_{W} is in a predetermined range, the improvement of the electron conductivity and the improvement of the ion conductivity can be balanced and both can be achieved, and the resistance can be reduced.

What is claimed is:

1. A positive electrode active material comprising a primary particle that is crystalline, the primary particle containing Li, a transition metal, and O, wherein:
La and W are present on a surface of the primary particle; and
in a case where an element analysis is performed from an outermost surface of the primary particle to 20 nm by X-ray photoelectron spectroscopy, and a proportion of La is defined as C_{La} and a proportion of W is defined as C_{W},
C_{La} and C_{W} satisfy 0.01≤C_{La}/C_{W}≤1.0.

2. The positive electrode active material according to claim 1, wherein:
a compound containing La and a compound containing W are provided on the surface of the primary particle;
and the compound containing La and the compound containing W are compounds having different compositions.

3. The positive electrode active material according to claim 2, wherein the compound containing La is particulate.

4. The positive electrode active material according to claim 2, wherein the compound containing W is pellicular.

5. A battery comprising:
a positive electrode active material layer containing a positive electrode active material;
a negative electrode active material layer containing a negative electrode active material; and
an electrolyte layer disposed between the positive electrode active material layer and the negative electrode active material layer,
wherein the positive electrode active material layer contains the positive electrode active material according to claim 1.
